(19) United States
(12) Patent Application Publication
(10) Pub. No.: US 2025/0216298 A1
(43) Pub. Date: Jul. 3, 2025

(54) FAN TESTING SYSTEM

(71) Applicant: BITMAIN TECHNOLOGIES INC., Beijing (CN)

(72) Inventor: You LI, Beijing (CN)

(21) Appl. No.: 19/080,154

(22) Filed: Mar. 14, 2025

Related U.S. Application Data
(63) Continuation of application No. PCT/CN2023/113604, filed on Aug. 17, 2023.

(30) Foreign Application Priority Data
Sep. 14, 2022 (CN) 202222434908.6

(51) Int. Cl. G01M 99/00; F04B 51/00

(52) U.S. Cl. CPC G01M 99/008; F04B 51/00

(57) ABSTRACT

A fan testing system, including an adjustable load apparatus, a fan board, a power supply apparatus, and a control apparatus, the control apparatus is connected to the power supply apparatus, the fan board, and the adjustable load apparatus, and the power supply apparatus is connected to the adjustable load apparatus and the fan board; the fan board includes multiple connection ports, and the connecting ports are configured to connect to a to-be-tested fan. Based on the fan testing system, by means of adjusting a resistance value of the adjustable load apparatus by the control apparatus to simulate a device in a practical scenario, and controlling the power supply apparatus to supply power to the adjustable load apparatus as well as the to-be-tested fan connected to the fan board by the control apparatus, the fan testing system is enabled to test whether the to-be-tested fan is qualified in different application scenarios.

### CROSS-REFERENCE TO RELATED APPLICATIONS

The present disclosure is a national stage of International application No. PCT/CN2023/113604, filed on Aug. 17, 2023, which claims priority to Chinese patent application No. 202222434908.6, entitled “FAN TESTING SYSTEM”, and filed with the China National Intellectual Property Administration on Sep. 14, 2022. Both of the aforementioned applications are hereby incorporated by reference in their entireties.

### TECHNICAL FIELD

The present disclosure relates to the field of test technologies, and in particular, to a fan testing system.

### BACKGROUND

In order to maintain normal operation of a device, a fan is usually used to reduce an operating temperature of the device. In order to test whether the fan is qualified, an operating parameter of the fan need to be tested. However, the inventor found that existing fan testing systems can only test whether the fan is qualified in a specific application scenario and cannot test whether the fan is qualified in different application scenarios.

### SUMMARY

Embodiments of the present disclosure provides a fan testing system aimed at enabling the fan testing system to test whether a fan is qualified in different application scenarios. The fan testing system includes:

an adjustable load apparatus, configured to simulate a device in a practical scenario;

a fan board, including multiple connection ports, where the connection ports are configured to connect a to-be-tested fan;

a power supply apparatus, connected to the adjustable load apparatus and the fan board, where the power supply apparatus is configured to supply power to the adjustable load apparatus as well as the to-be-tested fan connected to the fan board; and

a control apparatus, connected to the power supply apparatus, the fan board, and the adjustable load apparatus, where the control apparatus is configured to control operation of the power supply apparatus, the fan board, and the adjustable load apparatus, to complete test of the to-be-tested fan.

In a possible implementation, types of the multiple connection ports are different, and the connection ports of different types are configured to connect fans of different types.

In a possible implementation, the fan board includes multiple switch units, each of the connection ports is connected to the power supply apparatus through one of the switch units, and controlled ends of the switch units are connected to the control apparatus.

In a possible implementation, the adjustable load apparatus includes at least one of an adjustable resistor and an adjustable variable resistance box.

In a possible implementation, the fan testing system further includes:

a display apparatus, connected to the control apparatus, wherein the display apparatus is configured to display a test result.

In a possible implementation, the fan testing system further includes:

a server, connected to the control apparatus, where the server is configured to store a test result and configure a testing item of the control apparatus.

In a possible implementation, the fan testing system further includes:

a scanning apparatus, wherein the scanning apparatus is connected to the control apparatus and is configured to scan an identification code attached to the to-be-tested fan; and the control apparatus is configured to bind and save a test result of the to-be-tested fan with an identifier in the identification code.

In a possible implementation, the control apparatus includes a controller, where the controller is set on the fan board.

In a possible implementation, the power supply apparatus includes a first power supply port and a second power supply port, where the first power supply port is connected to the adjustable load apparatus and is configured to supply power to the adjustable load apparatus, and the second power supply port is connected to the fan board and is configured to supply power to the to-be-tested fan connected to the fan board.

In a possible implementation, the power supply apparatus further includes an access port, an AC-DC conversion circuit, a first DC-DC conversion circuit, and a second DC-DC conversion circuit; where the access port is connected to an input end of the AC-DC conversion circuit, and the access port is connected to utility power; output ends of the AC-DC conversion circuit are respectively connected to an input end of the first DC-DC conversion circuit and an input end of the second DC-DC conversion circuit; and an output end of the first DC-DC conversion circuit and an output end of the second DC-DC conversion circuit are respectively connected to the first power supply port and the second power supply port.

The fan testing system disclosed in the embodiments of the present disclosure includes the adjustable load apparatus, the fan board, the power supply apparatus, and the control apparatus. By means of adjusting a resistance value of the adjustable load apparatus by the control apparatus to simulate the device in the practical scenario, and controlling the power supply apparatus to supply power to the adjustable load apparatus as well as the to-be-tested fan connected to the fan board by the control apparatus, the fan testing system is enabled to test whether the to-be-tested fan is qualified in different application scenarios.

### BRIEF DESCRIPTION OF DRAWINGS

In order to more clearly illustrate technical solutions in embodiments of the present disclosure, a brief introduction will be given to accompanying drawings required for description of the embodiments. It is obvious that the accompanying drawings described below are some embodiments of the present disclosure; and for persons of ordinary skill in the art, other accompanying drawings can be obtained according to these accompanying drawings without creative labor.

FIG. 1 is a structural schematic block diagram of a fan testing system provided by an embodiment of the present disclosure.

FIG. 2 is a structural schematic block diagram of a power supply apparatus provided by an embodiment of the present disclosure.

FIG. 3 is a structural schematic block diagram of a fan board provided by an embodiment of the present disclosure.

FIG. 4 is a structural schematic block diagram of another fan board provided by an embodiment of the present disclosure.

FIG. 5 is a structural schematic block diagram of another fan testing system provided by an embodiment of the present disclosure.

### DESCRIPTION OF EMBODIMENTS

Below, the technical solutions in the embodiments of the present disclosure

will be clearly and completely described with reference to the accompanying drawings in the embodiments of the present disclosure. Obviously, the described embodiments are a part of the embodiments of the present disclosure, not all of them. Based on the embodiments in the present disclosure, all other embodiments obtained by persons of ordinary skill in the art without creative labor are within protection scope of the present disclosure.

Schematic diagrams shown in the accompanying drawings are only exemplary descriptions, and do not necessarily include all contents and operations/steps, nor do they have to be executed in a described order. For example, some operations/steps may also be decomposed, combined, or partially merged, and thus, practical executing order may change according to practical situations.

It should be understood that terms used in the specification of the present disclosure are only for purposes of describing specific embodiments and are not intended to limit the present disclosure. As used in the specification of the present disclosure, unless the context clearly indicates other situations, singular forms of “one”, “a”, and “the” are intended to include plural forms.

It should also be understood that the term “and/or” used in the specification of the present disclosure refers to any combination of one or more of listed relevant items and all possible combinations, and these combinations are included.

Below, some implementations of the present disclosure will be described in detail with reference to the accompanying drawings. In non-conflicting situations, the following embodiments and their features can be combined with each other.

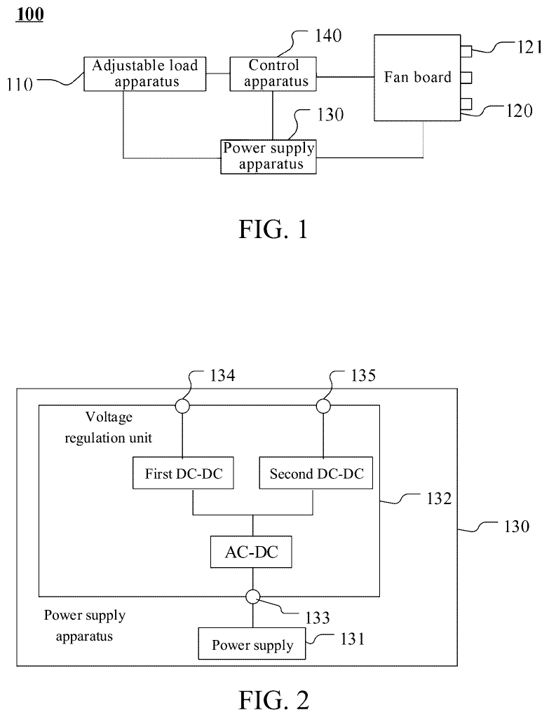

Please refer to FIG. 1, which is a structural schematic block diagram of a fan testing system 100 provided by an embodiment of the present disclosure. The fan testing system 100 provided by the embodiment of the present disclosure includes an adjustable load apparatus 110, a fan board 120, a power supply apparatus 130, and a control apparatus 140. The control apparatus 140 is connected to the power supply apparatus 130, the fan board 120, and the adjustable load apparatus 110. The power supply apparatus 130 is connected to the adjustable load apparatus 110 and the fan board 120. The adjustable load apparatus 110 is configured to simulate a device in a practical scenario. The power supply apparatus 130 is configured to supply power to the adjustable load apparatus 110 as well as a to-be-tested fan connected to the fan board 120. The fan board 120 includes multiple connection ports 121, and the connection ports 121 are configured to connect the to-be-tested fan. The control apparatus 140 is configured to control operation of the power supply apparatus 130, the fan board 120, and the adjustable load apparatus 110, to complete test of the to-be-tested fan. Specifically, the control apparatus 140 is configured to control the power supply apparatus 130 to supply power to the adjustable load apparatus 110 and the fan board 120 on one hand, and is configured to perform the test on the to-be-tested fan, as well as adjust a resistance value of the adjustable load apparatus 110 to simulate the device in the practical scenario on the other hand, and is configured to obtain an operating parameter of the to-be-tested fan and power consumption of the power supply apparatus 130 in yet another aspect, to complete the test of the to-be-tested fan according to the operating parameter and the power consumption of the power supply apparatus 130.

In practical applications, the control apparatus 140 is configured with a testing item. Before conducting formal test on the to-be-tested fan, a resistance value of the device, an output voltage value of a power supply, and a default range of power consumption of the power supply in the practical application scenario, and default ranges of the operating parameter of the to-be-tested fan are required to be input into the control apparatus 140, enabling the control apparatus 140 to test whether the to-be-tested fan is qualified in a certain practical application scenario according to the testing items.

The testing item includes testing whether the to-be-tested fan is qualified at a maximum rotational speed, testing whether the to-be-tested fan is qualified at a minimum rotational speed, and whether the to-be-tested fan is qualified when the to-be-tested fan is adjusted at a certain step speed; the operating parameter of the to-be-tested fan include but are not limited to at least one of an operating voltage, an operating current, an operating power, air volume, air pressure, a rotational speed, an instantaneous power change of the to-be-tested fan when the rotational speed of the to-be-tested fan is adjusted at a certain step speed, which then correspond to following corresponding default ranges: an operating voltage range, an operating current range, an operating power range, an air volume range, an air pressure range, a rotational speed range, a range of the instantaneous power change of the to-be-tested fan when the rotational speed of the to-be-tested fan is adjusted at the certain step speed.

It should be noted that the control apparatus 140 may be connected to the power supply apparatus 130, the fan board 120, and the adjustable load apparatus 110 through circuits, wired communication links, or wireless communication links. The embodiments disclosed in the present disclosure do not limit connection methods between the control apparatus 140 and the power supply apparatus 130, the fan board 120, as well as the adjustable load apparatus 110, as long as the above purposes of the control apparatus 140 can be achieved.

The device may be an electronic device (such as a computer, a mobile phone, and a tablet), a mechanical device (such as a jacquard machine, a packaging machine, and a compressor), a communication device (such as a base station, a switch, and a router), and an instrument device (such as a transmission electron microscope, a CT detector, and a nuclear magnetic resonance machine), etc. The present disclosure does not limit types and fields of the device, as long as it is a device requiring heat dissipation.

In some implementations, the control apparatus 140 includes a controller, where the controller may be a microcontroller unit (abbreviated as: MCU). The controller is set on the fan board, which can simplify the structure of the fan testing system.

In some implementations, the multiple connection ports 121 are numbered, and the control apparatus 140 is further configured to obtain a number of a connection port 121 of the to-be-tested fan corresponding to the operating parameter when acquiring the operating parameter of the to-be-tested fan and the power consumption of the power supply apparatus 130, in order to distinguish test results of different to-be-tested fans when test is performed on multiple to-be-tested fans.

In some implementations, types of the multiple connection ports 121 are different, and the connection ports 121 of different types are configured to connect fans of different types, so that the fan testing system 100 can test the fans of different types. It can be understood that the types of the multiple connection ports 121 may be completely or partially different.

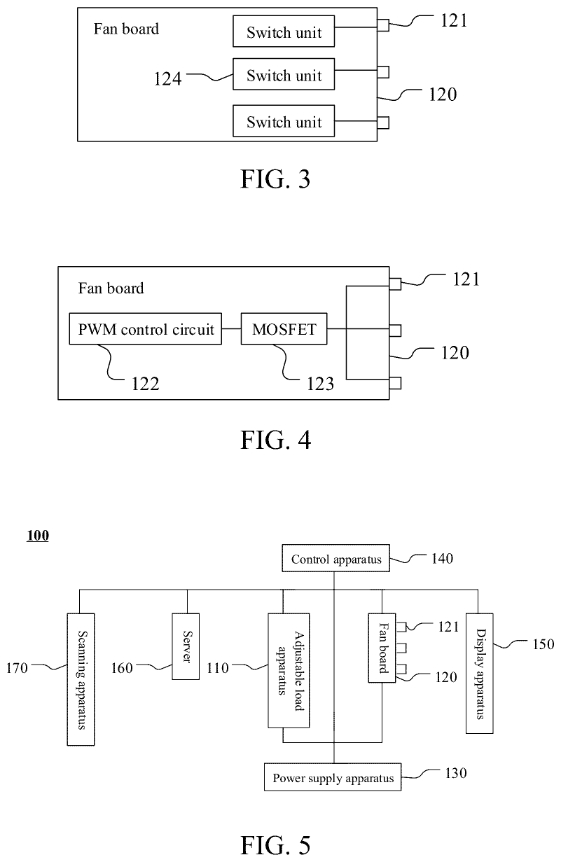

As shown in FIG. 3, in some implementations, the fan board 120 includes multiple switch units 124, and each connection port 121 is connected to the power supply apparatus 130 through a switch unit 124. Controlled ends of the switch units 124 are connected to the control apparatus 140, and the control apparatus 140 controls connection/disconnection between the to-be-tested fan and the power supply apparatus 130 by means of controlling the switch units 140, thereby achieving the connection/disconnection between the to-be-tested fan and the power supply apparatus 130, facilitating test of some of the to-be-tested fans.

In some implementations, the adjustable load apparatus 110 includes multiple adjustable loads, which are connected in series and parallel to test whether the fan is qualified in more practical application scenarios.

It should be noted that the adjustable loads may be at least one of adjustable resistors and adjustable variable resistance boxes. The embodiments disclosed in the present disclosure do not limit types of the adjustable loads, as long as functions of the adjustable loads can be achieved.

As shown in FIG. 2, in some implementations, the power supply apparatus 130 includes a first power supply port 134 and a second power supply port 135. The first power supply port 134 is connected to the adjustable load apparatus 110 and is configured to supply power to the adjustable load apparatus 110, and the second power supply port 135 is connected to the fan board 120 and is configured to supply power to the to-be-tested fan connected to the fan board 120.

Please refer to FIG. 2, the power supply apparatus 130 includes a power supply 131 and a voltage regulation unit 132. The voltage regulation unit 132 is configured to regulate output voltage of the power supply 131 under control of the control apparatus 140. An access port 133 of the voltage regulation unit 132 is connected to an output end of the power supply 131, and a first output end 134 (i.e., the first power supply port 134) and a second output end 135 (i.e., the second power supply port 135) of the voltage regulation unit 132 are respectively connected to the adjustable load apparatus 110 and the fan board 120. For example, the power supply 131 may be utility power, and the voltage regulation unit 132 may be a thyristor power regulator, a silicon-controlled rectifier power regulator, or a voltage conversion circuit.

It should be noted that the embodiments disclosed in the present disclosure do not limit a specific structure of the power supply apparatus 130. The above structure is only for the purpose of assisting understanding, and those skilled in the art may set the specific structure of the power supply apparatus 130 according to its function.

For example, as shown in FIG. 2, the power supply 131 is utility power, and the voltage regulation unit 132 is a voltage conversion circuit. The voltage conversion circuit includes the access port 133, an AC-DC conversion circuit, a first DC-DC conversion circuit, and a second DC-DC conversion circuit; the access port 133 is connected to an input end of the AC-DC conversion circuit, and the access port 133 is connected to the utility supply; output ends of the AC-DC conversion circuit are respectively connected to an input end of the first DC-DC conversion circuit and an input end of the second DC-DC conversion circuit, and an output end of the first DC-DC conversion circuit and an output end of the second DC-DC conversion circuit are respectively connected to the first power supply port 134 and the second power supply port 135. The AC-DC conversion circuit is configured to convert alternating current into direct current, the first DC-DC conversion circuit is configured to regulate voltage across the adjustable load apparatus 110, and the second DC-DC conversion circuit is configured to regulate voltage across the to-be-tested fan.

As shown in FIG. 4, in some implementations, the fan board 120 includes a MOSFET (Metal-Oxide-Semiconductor Field-Effect Transistor) 123 and a PWM (Pulse-Width Modulation) control circuit 122. An input end of the PWM control circuit 122 is connected to the second power supply port 135, an output end of the PWM control circuit 122 is connected to an input end of the MOSFET 123, and an output end of the MOSFET 123 is connected to the to-be-tested fan. When the control apparatus 140 adjusts the rotational speed of the to-be-tested fan, the PWM control circuit 122 sends a PWM control signal to the MOSFET 123 according to a fan rotational speed preset by the control apparatus 140, and the MOSFET 123 controls the connection/disconnection of the to-be-tested fan according to the PWM control signal, in order to achieve adjustment for the rotational speed of the to-be-tested fan by adjusting a duty cycle of the operating voltage of the to-be-tested fan.

As shown in FIG. 5, in some implementations, the fan testing system 100 further includes a display apparatus 150, where the display apparatus 150 is connected to the control apparatus 140 and is used to display a test result, and in such an implementation, whether the to-be-tested fan can operate normally in the practical scenario simulated by the adjustable load apparatus 110 is displayed.

It should be noted that the display apparatus 150 and the control apparatus 140 may be connected through circuits, wired communication links, or wireless communication links. The embodiments disclosed in the present disclosure do not limit connection methods between the control apparatus 140 and the display apparatus 150, as long as the above-mentioned purpose of the display apparatus 150 can be achieved.

In some implementations, the display apparatus 150 includes an indicator light controlled by the control apparatus 140, where the indicator light may display at least two colors. When the operating parameter of the to-be-tested fan are within a default operating parameter range of the to-be-tested fan and the power consumption of the power supply apparatus 130 is within the default range of the power consumption of the power supply, the indicator light displays a certain color of light (e.g., green light), indicating that the to-be-tested fan can perform normal heat dissipation on the device in the practical scenario which is simulated by the adjustable load apparatus 110, that is, the to-be-tested fan is qualified in this practical scenario. When the operating parameter of the to-be-tested fan are not within the default operating parameter range of the to-be-tested fan, or the power consumption of the power supply apparatus 130 is not within the default range of the power consumption of the power supply, the indicator light displays another color of light (e.g., red light), indicating that the to-be-tested fan cannot perform the normal heat dissipation on the device in the practical scenario which is simulated by the adjustable load apparatus 110, that is, the to-be-tested fan is not qualified in this practical scenario.

It should be noted that the two colors of the indicator light may be set according to a user's preferences and specific application scenarios. The embodiments disclosed in the present disclosure are not limited to using red and green colors, and colors such as yellow and green, purple and blue, and the like may be used as long as two different colors are displayed. The indicator light includes but is not limited to any one of an LED light and a tungsten filament light.

In some implementations, the display apparatus 150 includes multiple indicator lights, and a quantity of the indicator lights is the same as a quantity of the connection ports 121. The multiple indicator lights correspond one-to-one with the multiple connection ports 121, and each of the indicator lights is configured to display whether a to-be-tested fan connected to a connection port 121 corresponding to itself is qualified. In such an implementation, when test is performed on multiple to-be-tested fans, enabling a staff to select qualified fans according to the indicator lights can be achieved.

In some implementations, the display apparatus 150 includes a display screen controlled by the control apparatus 140, where the display screen may display at least two symbols. When the operating parameter of the to-be-tested fan is within the default operating parameter range of the to-be-tested fan and the power consumption of the power supply apparatus 130 is within a default range of the power consumption of the power supply, the display screen displays a certain symbol (e.g., Yes), indicating that the to-be-tested fan can perform the normal heat dissipation on the device in the practical scenario which is simulated by the adjustable load apparatus 110, that is, the to-be-tested fan is qualified in this practical scenario. When the operating parameter of the to-be-tested fan is not within the default operating parameter range of the to-be-tested fan, or the power consumption of the power supply apparatus 130 is not within the default range of the power consumption of the power supply, the display screen displays another symbol (e.g., No), indicating that the to-be-tested fan cannot perform the normal heat dissipation on the device in the practical scenario which is simulated by the adjustable load apparatus 110, that is, the to-be-tested fan is not qualified in this practical scenario.

It should be noted that the symbols displayed on the display screen may be set according to the user's preferences and the specific application scenarios. The embodiments disclosed in the present disclosure are not limited to using two symbols of “Yes” and “No”, for example, “Y” and “N”, “Yes” and “No” may be used, as long as two different symbols are displayed.

In some implementations, the display screen is configured to display a test result of the to-be-tested fan and a number of a connection port 121 connected to the to-be-tested fan under the control of the control apparatus 140. When the test is performed on the multiple to-be-tested fans, enabling the staff to select fans that can operate normally according to test results displayed on the screen can be achieved. As shown in FIG. 5, in some implementations, the fan testing system 100

further includes a server 160, where the server 160 is connected to the control apparatus 140 through a network. The server 160 is configured to store a test result and a test record, as well as to configure the testing item of the control apparatus 140, so that remote test of the to-be-tested fan and simultaneous test of whether the fan is qualified in multiple practical application scenarios can be achieved.

As shown in FIG. 5, in some implementations, the fan testing system 100 further includes a scanning apparatus 170, where the scanning apparatus 170 is connected to the control apparatus 140 and is configured to scan an identification code attached to the to-be-tested fan; and the control apparatus 140 is configured to bind and save the test result and the test record of the to-be-tested fan with an identifier in the identification code, in order to achieve traceability of the test result and test data of the to-be-tested fan after the to-be-tested fan enters the market and a malfunction occurs, thereby preventing fraudulent behavior by users.

In practical applications, specific principles of adopting the fan testing system 100 provided by the present disclosure to test a fan are as follows.

A staff inputs the resistance value of the device, the output voltage value of the power supply, and the default range of the power consumption of the power supply in the practical scenario, and the default operating parameter of the to-be-tested fan into the control apparatus 140 according to the practical application scenario of the to-be-tested fan.

For example, when whether the to-be-tested fan can perform normal heat dissipation on a jacquard machine is tested, a resistance value of the jacquard machine, an output voltage value of a power supply and a default range of power consumption of the power supply under an operating environment of the jacquard machine, and the default operating parameter of the to-be-tested fan are inputted into the control apparatus 140.

For example, when whether the to-be-tested fan can perform normal heat dissipation on a computer is tested, a resistance value of the computer, an output voltage value of a power supply and a default range of power consumption of the power supply under an operating environment of the computer, and the default operating parameter of the to-be-tested fan are inputted into the control apparatus 140.

After the resistance value of the device, the output voltage value of the power supply, the default range of the power consumption of the power supply, and the default operating parameter of the to-be-tested fan are input into the control apparatus 140 by the staff, the control apparatus 140 adjusts the resistance value of the adjustable load apparatus 110 and the output voltage value of the power supply apparatus 130 based on the resistance value of the device and the output voltage value of the power supply respectively, to cause the resistance value of the adjustable load apparatus 110 to be equal to the resistance value of the device, and to cause the output voltage value of the power supply apparatus 130 to be equal to the output voltage value of the power supply.

After finishing adjusting the resistance value of the adjustable load apparatus 110 and the output voltage of the power supply apparatus 130, the control apparatus 140 controls the power supply apparatus 130 to supply power to the adjustable load apparatus 110 and the to-be-tested fan based on the output voltage value of the power supply apparatus 130.

After the power is supplied to the adjustable load apparatus 110 and the to-be-tested fan, the control apparatus 140 performs test on the to-be-tested fan based on the testing item.

Specifically, the control apparatus 140 first tests whether the to-be-tested fan is qualified at the maximum rotational speed. When the control apparatus 140 tests whether the to-be-tested fan is qualified at the maximum rotational speed, the control apparatus 140 adjusts the rotational speed of the to-be-tested fan to the maximum rotational speed, and tests whether the rotational speed of the to-be-tested fan reaches the maximum rotational speed after a preset time interval; and if the rotational speed of the to-be-tested fan reaches the maximum rotational speed, the control apparatus 140 acquires an operating parameter of the to-be-tested fan at the maximum rotational speed and power consumption of the power supply apparatus 130. It can be understood that if the rotational speed of the to-be-tested fan does not reach the maximum rotational speed, the to-be-tested fan is not qualified at the maximum rotational speed. The control apparatus 140 compares the operating parameter of the to-be-tested fan at the maximum rotational speed with the default operating parameter range, and compares the power consumption of the power supply apparatus 130 with the default range of the power consumption of the power supply; and if the operating parameter is within the default working parameter range and the power consumption of the power supply apparatus 130 is within the default range of the power consumption of the power supply, the to-be-tested fan is qualified at the maximum rotational speed.

The control apparatus 140 then tests whether the to-be-tested fan is qualified at the minimum rotational speed. When the control apparatus 140 tests whether the to-be-tested fan is qualified at the minimum rotational speed, the control apparatus 140 adjusts the rotational speed of the to-be-tested fan to the minimum rotational speed and tests whether the rotational speed of the to-be-tested fan reaches the minimum rotational speed after a preset time interval; and if the rotational speed of the to-be-tested fan reaches the minimum rotational speed, the control apparatus 140 acquires an operating parameter of the to-be-tested fan at the minimum rotational speed and power consumption of the power supply apparatus 130. It can be understood that if the rotational speed of the to-be-tested fan does not reach the minimum rotational speed, the to-be-tested fan is not qualified at the minimum rotational speed. The control apparatus 140 compares the operating parameter of the to-be-tested fan at the minimum rotational speed with the default operating parameter range, and compares the power consumption of the power supply apparatus 130 with the default range of the power consumption of the power supply; and if the operating parameter is within the default operating parameter range and the power consumption of the power supply apparatus 130 is within the default range of the power consumption of the power supply, the to-be-tested fan is qualified at the minimum rotational speed.

The control apparatus 140 finally tests whether the to-be-tested fan is qualified when the rotational speed of the to-be-tested fan is adjusted at a certain step speed. When the control apparatus 140 tests whether the to-be-tested fan is qualified when the rotational speed of the to-be-tested fan is adjusted at the certain step speed, the control apparatus 140 adjusts the rotational speed of the to-be-tested fan at the certain step speed, and tests whether the rotational speed of the to-be-tested fan reaches a preset rotational speed after a preset time interval; and if the rotational speed of the to-be-tested fan reaches the preset rotational speed, the control apparatus 140 acquires an operating parameter of the to-be-tested fan at the preset rotational speed and power consumption of the power supply apparatus 130. It can be understood that if the to-be-tested fan does not reach the preset rotational speed, the to-be-tested fan is not qualified at the preset rotational speed. The control apparatus 140 compares the operating parameter of the to-be-tested fan at the preset rotational speed with the default operating parameter range, and compares the power consumption of the power supply apparatus 130 with the default range of the power consumption of the power supply; and if the operating parameter is within the default operating parameter range and the power consumption of the power supply apparatus 130 is within the default range of the power consumption of the power supply, the to-be-tested fan is qualified at the preset rotational speed.

It should be noted that the step speed refers to a rotational speed that needs to be increased each time when a rotational speed of a fan is adjusted from small to large. For example, the step speed being 10% means that the rotational speed of the fan needs to be increased by 10% when the rotational speed of the fan is adjusted each time. It is required to test multiple times whether the to-be-tested fan is qualified when the rotational speed of the to-be-tested fan is adjusted at the certain step speed, and when a test result in each time is qualified, the to-be-tested fan is qualified in the case of adjusting the rotational speed of the to-be-tested fan at this certain step speed. When the rotational speed of the to-be-tested fan is adjusted at the certain step speed, it may be done by gradually adjusting the rotational speed of the to-be-tested fan from the minimum rotational speed to the maximum rotational speed, or by gradually adjusting the rotational speed of the to-be-tested fan from a smaller rotational speed to a larger rotational speed. Preferably, the rotational speed of the to-be-tested fan is adjusted from the minimum rotational speed to the maximum rotational speed.

For example, adjusting the rotational speed of the to-be-tested fan from the minimum rotational speed to the maximum rotational speed at a step speed of 10% requires 10 tests. Each test corresponds to one preset rotational speed. When a test result of the to-be-tested fan is qualified at each preset rotational speed, the to-be-tested fan is qualified in the case of adjusting the rotational speed of the to-be-tested fan at the step speed of 10%.

For example, adjusting the rotational speed of the to-be-tested fan from 40% of the maximum rotational speed to 80% of the maximum rotational speed at a step speed of 20% requires 2 tests. Each test corresponds to one preset rotational speed. When a test result of the to-be-tested fan is qualified at each preset rotational speed, the to-be-tested fan is qualified in the case of adjusting the rotational speed of the to-be-tested fan at the step speed of 20%.

It can be understood that in the above test process, in the case where the operating parameter includes at least two operating parameter, if at least one of the operating parameter is not within a default operating parameter range thereof, the to-be-tested fan is not qualified.

After completing the above testing item, the control apparatus 140 analyzes whether the to-be-tested fan is qualified in the practical application scenario and saves an analysis result.

If the to-be-tested fan is qualified at the maximum rotational speed, at the minimum rotational speed, and when the rotational speed of the to-be-tested fan is adjusted at the certain step speed, then the to-be-tested fan is qualified in the practical application scenario.

It should be noted that in the testing items disclosed in the present disclosure, order in which the control apparatus 140 executes each test item is not limited, and a staff may configure it according to a practical testing requirement. Moreover, the testing items may be configured in the control apparatus 140 according to the practical test requirement, and are not limited to the testing items disclosed in the present disclosure.

In some implementations, before analyzing whether the to-be-tested fan is qualified in the practical application scenario, the control apparatus 140 will also save the test record of the to-be-tested fan, so as to analyze specific reasons why the to-be-tested fan is not qualified when the to-be-tested fan is not qualified in the practical application scenario.

The test record includes the resistance value of the adjustable load, the output voltage value of the power supply apparatus, the operating parameter of the to-be-tested fan at the maximum rotational speed as well as the power consumption of the power supply apparatus 130 acquired by the control apparatus 140, the operating parameter of the to-be-tested fan at the minimum rotational speed as well as the power consumption of the power supply apparatus 130 acquired by the control apparatus 140, and the operating parameter of the to-be-tested fan at the preset rotational speed as well as the power consumption of the power supply apparatus 130 acquired by the control apparatus 140.

In some implementations, the control apparatus 140 binds and saves the test result and the test record of the to-be-tested fan with the identifier in the identification code attached to the to-be-tested fan, in order to achieve traceability of the test result and the test data of the to-be-tested fan after the to-be-tested fans enters the market a malfunction occurs, thereby preventing the fraudulent behavior by the users.

The above are only specific implementations of the present disclosure, but the protection scope of the present invention is not limited to this. Any skilled person familiar with the technical field in the art can easily think of various equivalent modifications or substitutions within the technical scope disclosed in the present invention, and these modifications or substitutions should be included in the protection scope of the present invention. Therefore, the protection scope of the present invention should be based on the protection scope of the claims.

What is claimed is:

1. A fan testing system, comprising:
an adjustable load apparatus, configured to simulate a device in a practical scenario;
a fan board, comprising multiple connection ports, wherein the connection ports are configured to connect a to-be-tested fan;
a power supply apparatus, connected to the adjustable load apparatus and the fan board, wherein the power supply apparatus is configured to supply power to the adjustable load apparatus as well as the to-be-tested fan connected to the fan board;
a control apparatus, connected to the power supply apparatus, the fan board, and the adjustable load apparatus, wherein the control apparatus is configured to control operation of the power supply apparatus, the fan board, and the adjustable load apparatus, to complete test of the to-be-tested fan.

2. The fan testing system according to claim 1, wherein types of the multiple connection ports are different, and the connection ports of different types are configured to connect fans of different types.

3. The fan testing system according to claim 1, wherein the fan board comprises multiple switch units, and each of the connection ports is connected to the power supply apparatus through one of the switch units, and controlled ends of the switch units are connected to the control apparatus.

4. The fan testing system according to claim 1, wherein the adjustable load apparatus comprises at least one of an adjustable resistor and an adjustable variable resistance box.

5. The fan testing system according to claim 1, wherein the fan testing system further comprises:
a display apparatus, connected to the control apparatus, wherein the display apparatus is configured to display a test result.

6. The fan testing system according to claim 1, wherein the fan testing system further comprises:
a server, connected to the control apparatus, wherein the server is configured to store a test result and configure a testing item of the control apparatus.

7. The fan testing system according to claim 1, wherein the fan testing system further comprises:
a scanning apparatus, wherein the scanning apparatus is connected to the control apparatus and is configured to scan an identification code attached to the to-be-tested fan; and the control apparatus is configured to bind and save a test result of the to-be-tested fan with an identifier in the identification code.

8. The fan testing system according to claim 1, wherein the control apparatus comprises a controller, and the controller is set on the fan board.

9. The fan testing system according to claim 1, wherein the power supply apparatus comprises a first power supply port and a second power supply port, the first power supply port is connected to the adjustable load apparatus and is configured to supply power to the adjustable load apparatus, and the second power supply port is connected to the fan board and is configured to supply power to the to-be-tested fan connected to the fan board.

10. The fan testing system according to claim 9, wherein the power supply apparatus further comprises an access port, an AC-DC conversion circuit, a first DC-DC conversion circuit, and a second DC-DC conversion circuit; the access port is connected to an input end of the AC-DC conversion circuit, and the access port is connected to utility power; output ends of the AC-DC conversion circuit are respectively connected to an input end of the first DC-DC conversion circuit and an input end of the second DC-DC conversion circuit, and an output end of the first DC-DC conversion circuit and an output end of the second DC-DC conversion circuit are respectively connected to the first power supply port and the second power supply port.
